(19) United States
(12) Patent Application Publication
(10) Pub. No.: US 2023/0058933 A1
(43) Pub. Date: Feb. 23, 2023

(54) SYSTEMS AND METHODS FOR PREVENTING DUPLICATE PAYMENTS

(71) Applicant: Wells Fargo Bank, N.A., San Francisco, CA (US)

(72) Inventors: Gregory R. Connor, Lake Oswego, OR (US); Gayatri Malladi, Fremont, CA (US)

(21) Appl. No.: 16/443,382

(22) Filed: Jun. 17, 2019

(51) Int. Cl. G06Q 20/10; G06Q 20/08

(52) U.S. Cl. CPC G06Q 20/10; G06Q 20/085

(57) ABSTRACT

Systems and methods relate to detecting duplicate payments. A system includes a network interface and a processing circuit including a memory and at least one processor. The memory stores instructions that are executable by the at least one processor to provide a user interface to a user device associated with a user; receive a payment request from the user device; and retrieve, based on a first set of rules, a number of payment records from a number of systems of record. The instructions further cause the system to filter, based on a second set of rules, the retrieved number of payment records; perform a first comparison and a second comparison of attribute(s) of the payment request to attribute(s) of each of the retrieved or filtered payment records; determine, based on the comparisons, if the payment request is a duplicate payment request; and present a notification describing the duplicate payment request.

### BACKGROUND

Individuals often make payments through a website or mobile application that relates to one or more disparate accounts. For example, a banking customer may log into a financial institution's website to manage a checking account, mortgage account, and savings account. The website or mobile application is often accessible to more than one user. For example, a husband and wife may both have access to the same account. Furthermore, the website or mobile application may allow one or more payment types. For example, a user may schedule a recurring payment or make a one-time payment.

### SUMMARY

One embodiment relates to a system for detecting duplicate payments including a network interface configured to communicate, via a network, with a provider computing system and a user device. The provider computing system is associated with an accounts provider, and the user device is associated with a user holding one or more accounts with the accounts provider. The system further includes a processing circuit including a memory and at least one processor, the memory storing instructions that are executable by the at least one processor to provide a user interface to a user device associated with the user and receive a payment request from the user device via the user interface, the payment request indicating a desired transfer of funds from an account held by the user with the accounts provider. The instructions also cause the system to retrieve, based on a first set of rules, a number of payment records from a number of systems of record associated with the accounts provider and filter, based on a second set of rules, the retrieved number of payment records. The instructions further cause the system to perform a first comparison and a second comparison. Each of performing the first comparison and performing the second comparison includes comparing one or more attributes of the payment request to one or more attributes of each of the retrieved number of payment records or the filtered number of payment records. The instructions additionally cause the system to determine, based on the first and second comparisons, if the payment request is a duplicate payment request with at least one payment record and, in response to determining that the payment request is a duplicate payment request, present to the user, via the user device, a notification describing the duplicate payment request.

In some embodiments, each of the number of payment records is associated with a processed payment, a pending payment, or a scheduled payment. In some embodiments, each of the first set of rules and the second set of rules is based on at least one of identities of the number of systems of record, payment types of the plurality of payment records, or account types of the plurality of payment records.

In some embodiments, the instructions further cause the system to compare at least a payment funding account, a payment date, a payment amount, a payment source, and a payment destination of the payment request to at least a payment funding account, a payment date, a payment amount, a payment source, and a payment destination of each of the plurality of payment records. In some embodiments, the duplicate payment request is one of an exact duplicate or a potential duplicate. In some embodiments, the instructions cause the system to determine that the payment request is an exact duplicate in response to the comparison comprising matches between the payment funding account, the payment date, the payment amount, the payment source, and the payment destination of the payment request and a payment record. In some embodiments, the notification requires the user to select between modifying one or more attributes of the payment request or cancelling the payment request.

In some embodiments, the instructions cause the system to determine that the payment request is a potential duplicate in response to the comparison comprising matches between the payment amount and the payment destination of the payment request and at least one payment record. In some embodiments, the notification requires the user to acknowledge the potential duplicate to continue the payment request. In some embodiments, the instructions further cause the system to, in response to determining that the payment request is a duplicate payment request with more than one payment record, display the more than one payment record hierarchically within a second notification.

Another embodiment relates to a method of detecting duplicate payments. The method includes providing a user interface to a user device associated with a user and receiving a payment request from the user device via the user interface. The payment request indicates a desired transfer of funds from an account held by the user with an accounts provider. The method also includes retrieving, based on a first set of rules, a number of payment records from a number of systems of record associated with the accounts provider and filtering, based on a second set of rules, the retrieved number of payment records. The method additionally includes performing a first comparison and a second comparison. Each of performing the first comparison and performing the second comparison includes comparing one or more attributes of the payment request to one or more attributes of each of the retrieved number of payment records or the filtered number of payment records. The method further includes determining, based on the first and second comparisons, if the payment request is a duplicate payment request with at least one payment record and, in response to determining that the payment request is a duplicate payment request, presenting to the user, via the user device, a notification describing the duplicate payment request.

Another embodiment relates to a duplicate payment detection system including a network interface configured to communicate, via a network, with a provider computing system and a user device. The provider computing system is associated with an accounts provider, and the user device is associated with a user holding one or more accounts with the accounts provider. The system further includes a processing circuit including a memory and at least one processor, the memory storing instructions that are executable by the at least one processor to provide a user interface to the user device associated with the user and receive a payment request from the user device via the user interface, the payment request indicating a desired transfer of funds from an account held by the user with the accounts provider. The instructions also cause the system to retrieve, based on a first set of rules, a number of payment records from a number of systems of record associated with the accounts provider and compare one or more attributes of the payment request to one or more attributes of each of the retrieved number of payment records to determine if the payment request is an exact duplicate payment request. The instructions further cause the system to, in response to determining that the payment request is not an exact duplicate payment request, filter, based on a second set of rules, the number of payment records and compare the one or more attributes of the payment request to one or more attributes of each of the filtered number of payment records to determine if the payment request is a potential duplicate payment request. In some embodiments, the instructions further cause the system to, in response to determining that the payment request is a potential duplicate payment request, provide to the user, via the user device, a notification describing the potential duplicate payment request.

### BRIEF DESCRIPTION OF THE FIGURES

FIG. 1 is a block diagram of a system configured to prevent duplicate payments, according to an exemplary embodiment.

FIG. 2 is a flow diagram of a method to prevent duplicate payments, according to an exemplary embodiment.

FIG. 3 is a flow diagram of a method of retrieving the payment records of FIG. 2, according to an exemplary embodiment.

FIG. 4 is a flow diagram of a method of comparing the payment requests to the payment records of FIG. 2, according to an exemplary embodiment.

FIG. 5 is a flow diagram of a method of determining if the payment request of FIG. 2 is a duplicate payment, according to an exemplary embodiment.

FIG. 6 is a user interface illustrating a notification for an exact duplicate payment, according to an exemplary embodiment.

FIG. 7 is a user interface illustrating a notification for an exact duplicate payment, according to an exemplary embodiment.

FIG. 8 is a user interface illustrating a notification for a potential duplicate payment, according to an exemplary embodiment.

FIG. 9 is a user interface illustrating a notification for a potential duplicate payment, according to an exemplary embodiment.

### DETAILED DESCRIPTION

Referring generally to the figures, various systems and methods for identifying and notifying a user of duplicate payments are described herein. As used herein, a “duplicate payment” includes a payment request input by a user that includes one or more attributes matching one or more corresponding attributes in an existing payment record (e.g., a processed or scheduled payment). A user may input a payment request via a user interface (e.g., provided via a website, a mobile application, etc.) to be submitted to a financial institution. Prior to submittal, a computing system may review one or more systems of record to identify one or more payment records with matching attributes (e.g., a matching user account, a payment date, a payment amount, a payment source, a payment destination, etc.) to the payment request. For example, the computing system may review a first system of record storing payment records for mortgages, a second system of record storing payment records for credit cards and some personal lines of credit, a third system of record storing payment records for student loans, and a fourth system of record storing payment records for home equity lines and loans, other personal lines and loans, and auto loans. The computing system may determine the payment request is a duplicate payment based on a number and type of the matching attributes. For example, a payment request for a $42.00 transfer from a checking account to a credit account on Oct. 12, 2018 may be determined to be a duplicate of a payment record for a $42.00 transfer from the same checking account to the same credit account on Oct. 10, 2018.

The computing system may distinguish between two types of duplicate payments. A duplicate payment may be an exact duplicate or a potential duplicate. In various embodiments, an exact duplicate is a duplicate payment having the same or substantially the same attributes as a payment record. For example, the computing system may determine that a payment request with the same user account, payment date, payment amount, payment source, and payment destination as that of an existing payment record is an exact duplicate. In some embodiments, the computing system may notify the user of the exact duplicate and require the user to modify one or more attributes of the payment request before submittal. For example, the computing system may require the user to change the payment source of the payment request. In various embodiments, a potential duplicate is a duplicate payment having some, but not all, of the same attributes as one or more payment records. For example, the computing system may determine that a payment request with the same payment destination and payment amount as that of an existing payment record is a potential duplicate. In some embodiments, the computing system may notify the user of the potential duplicate but may allow the user to submit the payment request without modification.

An example implementation may be described as follows. A user who wishes to balance a credit account is presented with a website. The user inputs a source checking account, a payment amount, a payment date, and the destination credit account. In one example, a computing system identifies a payment record from earlier that day associated with the user and having the same source checking account, payment amount, payment date, and destination credit account. In response, the computing system presents the user with a notification reading, “We found 1 or more duplicate payments. These will not be processed. Please review the payment details below.” The user modifies the source checking account to be a source savings account and selects “continue” on the notification. In another example, the computing system identifies a one-time payment and a recurring payment both having the same payment amount and destination credit account as the payment request. In response, the computing system presents a general notification reading, “Are you making a duplicate payment? We found 1 or more payments for the same amount. Please review the payment details below.” The computing system also presents a first specific notification associated with the one-time payment, reading, “Other payment(s) to this payee for the same amount: Pending, dated Aug. 21, 2018. Select the ‘X’ in the payment header if you want to cancel the payment you are setting up,” and a second specific notification associated with the recurring payment, reading, “Other payment(s) to this payee for the same amount: Bill Pay scheduled for 09/20/18. Select ‘X’ in the payment header if you want to cancel the payment you are setting up.” However, the user still wishes to make the payment and therefore submits the payment without further modification.

The duplicate payment detection system described herein offers several technical and commercial advantages over conventional methods of payment submission. One problem with existing payment submission systems is that a user must manually review the transactions associated with an account to avoid duplicate payments. Accordingly, it is often difficult for a user to verify that a payment is unique. For example, a husband may make a mortgage payment, and later a wife may repeat the same mortgage payment by accident. As another example, if a husband and wife share a credit account, they may accidentally duplicate payments to the account if they do not communicate between each other regarding the payments and/or manually review previous transactions. Accordingly, a user is at risk of making duplicate payments with existing payment accounts.

Unintentional duplicate payments are a nuisance to users. Furthermore, each payment is associated with a transactional cost. When a payment is submitted, the request must be communicated over a network, for example, via an MT103 Society for Worldwide Interbank Financial Telecommunication (“SWIFT”) message. Use of such networks creates a transactional cost to a provider with which the user holds one or more accounts. Therefore, duplicate payments create excess transactional costs.

In addition to transactional costs, duplicate payments create excess computing overhead. A number of computing systems are involved in processing every payment. An individual may make a few to dozens of payments a day, and there may be hundreds of thousands, millions, or even tens of millions of individuals having accounts with an accounts provider. Therefore, if even a fraction of the individuals having accounts with a provider make duplicate payments, the excess computing overhead required to process the duplicate payments can be very large. The excess computing overhead ties up computing resources of computing systems that could be used otherwise.

The systems and methods described herein allow an accounts provider to detect exact and potential duplicate payments at the time a user submits a payment request. By detecting exact and potential duplicate payments before a payment request is delivered for processing, an accounts provider may avoid excess transactional costs, such as unnecessary MT103 SWIFT messages. The accounts provider may also free computing systems used to submit and process payments for other tasks, thereby improving the functioning of these computing systems.

The duplicate payment detection systems and methods described herein also include a number of specific rules for retrieving and filtering payment records. The rules reduce the number of payment records that need to be compared to the payment request to determine if the payment request is a duplicate. Comparing a payment request to a single payment record can include comparing multiple fields between the payment request and the payment record. For example, a computing system may compare a checking account, payment amount, payment date, and destination credit account between the payment request and the payment record. A computing cost is associated with each comparison. Therefore, by using these rules for retrieving and filtering payment records, the duplicate payment detection system described herein reduces the computing costs associated with determining if a payment request is a duplicate by reducing the number of payment records to which the payment request must be compared to more relevant payment records.

Additionally, unintentional duplicate payments may be difficult for users to detect, as detecting these payments may require users to manually review transaction histories. If the user holds more than one payment account with an accounts provider, this may further require the user to review the transaction histories for these multiple, separate payment accounts. The duplicate payment detection systems and methods described herein remove the need for time-consuming manual labor typically involved in reviewing transaction histories, which improves the user's experience with the accounts provider. Furthermore, because the duplicate payment detection systems and methods described herein help eliminate duplicate payments, they also help eliminate having to fix the duplicate payments after submission and processing. For example, remedying a submitted or processed duplicate payment may include manual review of payment records and information surrounding the duplicate payment, which requires user and/or employee time. Furthermore, fixing duplicate payments may require excess computing overhead associated, for example, with processing an updated payment. Therefore, eliminating duplicate payments further reduces the costs of excess user and employee time and excess computing overhead. For at least these reasons, a system to notify users and prevent duplicate payments is beneficial to accounts providers.

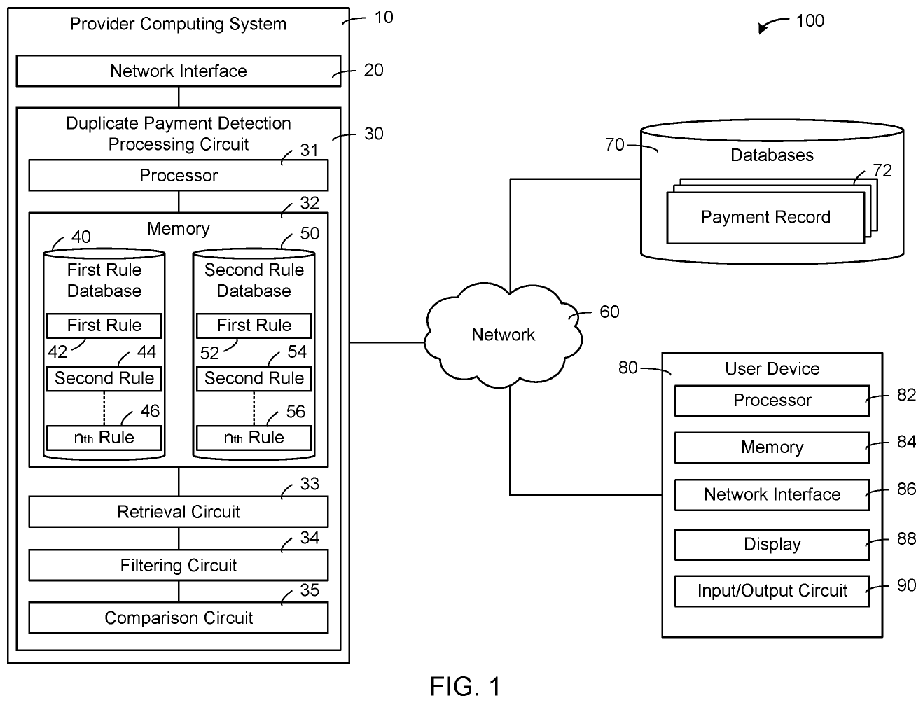

Referring now to FIG. 1, a block diagram of system 100 configured to prevent duplicate payments is shown, according to an exemplary embodiment. System 100 includes provider computing system 10, network 60, one or more databases 70, and user device 80. System 100 is configured to receive a payment request from a user, retrieve a number of payment records, compare the payment request to the number of payment records, determine if the payment request is a duplicate payment, and present a notification to the user in response to the determination, as described in greater detail below.

Network 60 may support communication between provider computing system 10 and one or more other systems or components (e.g., user device 80, databases 70, etc.). Network 60 may be an internal network (e.g., intranet, local area network (“LAN”), etc.) or may be an external network (e.g., the Internet, T1 line, extranet, wide area network (“WAN”), enterprise private network, etc.).

User device 80 is associated with a user that submits a payment to provider computing system 10. For example, the user may hold a first account (e.g., demand deposit account, credit account, etc.) with the provider associated with the provider computing system 10 and may submit a payment from the first account to settle a balance on a second account. User device 80 includes processor 82, memory 84, network interface 86, display 88, and input/output circuit 90. In some embodiments, user device 80 may be a mobile phone, tablet, computer or other personal device. In some embodiments, user device 80 may be a mobile device (e.g., a smartphone, a laptop, a smart watch, etc.). In some embodiments, user device 80 may be an ATM or customer representative terminal.

Network interface 86 is used to establish connections via network 60 between user device 80 and components of system 100, such as provider computing system 10. Network interface 86 includes hardware and/or program logic that facilitates connections of user device 80 to network 60. Input/output circuit 90 is structured to receive communications from and provide communications to a user of user device 80. In this regard, input/output circuit 90 is structured to exchange data, communications, instructions, etc. with an input/output device or component of user device 80. Accordingly, in one embodiment, the input/output circuit 90 may include an input/output device, such as a touchscreen, a keyboard, a microphone, or a speaker. In various embodiments, display 88 may be a screen, a touchscreen, and the like. In some embodiments, display 88 may be a component of input/output circuit 90.

User device 80 receives a payment request from a user (e.g., via input/output circuit 90) and transmits the payment request via network interface 86 to provider computing system 10. In some embodiments, a user using user device 80 may submit a payment request via an interface (e.g., an online banking portal, a mobile application, etc.). For example, user device 80 may present a website (e.g., an online banking portal) or mobile application (e.g., mobile banking application) to the user to submit the payment request. In some arrangements, user device 80 may interface with provider computing system 10 to present user interfaces relating to submitting a payment. User device 80 may also display, via display 88, a notification from duplicate payment detection processing circuit 30 of a duplicate payment, as described in further detail below.

Databases 70 are associated with the provider and retrievably store one or more payment records 72, including one or more payment records 72 associated with the user. Databases 70 may be one or more financial systems of record (e.g., storing payment records for mortgages, storing payment records for credit cards and personal lines of credit, storing payment records for student loans, storing payment records for home equity lines and loans, other personal lines and loans, and auto loans, etc.) associated with provider computing system 10. In various embodiments, at least some databases 70 may be included in the provider computing system 10 and/or at least some databases 70 may be external to provider computing system 10 (e.g., operated by third-parties). Databases 70 may also store information relating to one or more financial accounts (e.g., in connection with the one or more payment records 72). For example, databases 70 may store account balances, transactions, and payment processing information. Payment records 72 correspond to one or more posted, pending, and/or scheduled payments. For example, a first payment record 72 may be for a scheduled payment that becomes a pending payment when the date of payment arrives and finally becomes a posted payment when the pending payment clears. Each of payment records 72 includes one or more attributes, for example, user account, payment date, payment amount, payment source, and payment destination attributes.

Provider computing system 10 is associated with a provider of financial services. For example, the provider may provide banking services to individuals and entities (e.g., demand deposit account services, other deposit account services, credit account services, mobile wallet services, etc.). As an illustration, the user associated with user device 80 may hold an account (e.g., demand deposit account, credit account, etc.) with the provider associated with provider computing system 10 that the user can use to make payments. Provider computing system 10 may include various servers and computing systems or may be embodied as a single computing device. Provider computing system 10 includes at least one processor and memory to perform the various functions described herein. Provider computing system 10 may also communicate with external computing systems, for example, external service providers.

Provider computing system 10 includes network interface 20 and duplicate payment detection processing circuit 30. Duplicate payment detection processing circuit 30 is structured to detect duplicate payment requests and notify a user of the duplicate payment requests as described in detail below. In some embodiments, duplicate payment detection processing circuit 30 implements a program, such as a function, to carry out the aspects described herein. According to one embodiment, duplicate payment detection processing circuit 30 includes processor 31, memory 32, retrieval circuit 33, filtering circuit 34, and comparison circuit 35. Memory 32 includes one or more databases, such as a first rule database 40 and second rule database 50, as shown in FIG. 1. In some embodiments, memory 32 also stores instructions to cause processor 31 to carry out the aspects described herein.

First rule database 40 includes one or more rules 42-46 that describe which payment records 72 to retrieve. Rules 42-46 may vary based on one or more factors. For example, a first set of rules associated with pending payments and a second set of rules associated with hard-posted payments may exist for a credit cards and lines of credit database 70, while a third set of rules associated with one-time payments scheduled for a future date may exist for a home equity loans and auto loans database 70. Examples of rules 42-46 are provided in more detail below. Second rule database 50 includes one or more rules 52-56 that describe which payment records 72 to compare via comparison circuit 35. Rules 52-56 may vary based on one or more factors. For example, a first rule may relate to a pending payment for a student loan account, and a second rule may relate to a hard-posted payment for a mortgage account. Examples of rules 52-56 are also provided below.

Retrieval circuit 33 is communicably coupled to memory 32, filtering circuit 34, and comparison circuit 35 and is configured to retrieve one or more payment records 72 from databases 70 and send the payment records 72 to filtering circuit 34 and/or comparison circuit 35 as described in greater detail below. Retrieval circuit 33 may communicate with first rule database 40 to use rules 42-46 in retrieving the one or more payment records 72 from databases 70.

In one example, a general rule for retrieval of payments for all databases 70 is retrieving payments that the user can see in an online banking portal associated with the provider computing system 10. In another example, various rules apply to a first database 70 that stores payment records for consumer cards (e.g., Visa® and American Express®), business direct cards (e.g., Visa® and Mastercard®), personal lines of credit, and retail services credit cards. These rules may include (1) retrieving hard-posted payments up to five calendar days preceding the current date. If retrieval circuit 33 determines that hard-posted payments to a particular sub account are being requested, then the rules include retrieving the payments to the master account associated with the sub account. If retrieval circuit 33 determines that hard-posted payments to a particular master account are requested, then the rules include retrieving the payments to just the master account. The rules may also (2) include retrieving payments that are processing but have not yet posted to the system of record for the first database 70 (e.g., “pending” payments on the account activity transaction table for the credit account). If retrieval circuit 33 determines that pending payments to a particular sub account are requested, then the rules include retrieving the payments to the master account and the sub account associated with the master account. If retrieval circuit 33 determines that payments to a particular master account are requested, then the rules include retrieving the payments to the master account and each associated sub account. The rules may further include (3) retrieving payments that have not yet started processing and are still held in a bill pay (e.g., scheduled using an “eBill” online functionality) and/or an online payment system (e.g., in a “scheduled” status). For example, these payments may include any one-time payments scheduled for any future date. Additionally, the rules may include (4) retrieving the next instance of a recurring or automatic payment from the bill pay and/or online payments system. If a payment retrieved from bill pay is a duplicate of a payment otherwise retrieved (e.g., retrieved as a “scheduled” payment), then the rules include removing the bill pay payment record from the retrieved payment records.

In another example, various rules apply to a second database 70 that stores payment records for home equity, personal credit, and auto loan and/or line-of-credit accounts. The rules may include (1) retrieving hard-posted payments up to five calendar days preceding the current date. If retrieval circuit 33 determines that hard-posted payments to a particular sub account are requested, then the rules include retrieving the payments to the particular sub account. If retrieval circuit 33 determines that hard-posted payments to a particular master account are requested, then the rules include retrieving the payments to the master account. If retrieval circuit 33 determines hard-posted payments to a group account are requested, the rules include retrieving the payments to the master and sub accounts associated with the group account. The rules may also include (2) retrieving payments that are processing but have not yet posted to the system of record for the second database 70 (e.g., “pending” payments on the account activity transaction table for the credit account). If retrieval circuit 33 determines that pending payments to a particular sub account are requested, then the rules include retrieving the payments to the particular sub account. If retrieval circuit 33 determines that pending payments to a particular master account are requested, then the rules include retrieving the payments to just the master account. If retrieval circuit 33 determines that pending payments to a group account are requested, the rules include retrieving the payments to the master and sub accounts associated with the group account. The rules may further include (3) retrieving payments that have not yet started processing and are still held in a bill pay and/or an online payments system (e.g., in a “scheduled” status). The rules may further include (4) retrieving the next instance of a recurring or automatic payment from the bill pay and/or online payments system. In some embodiments, recurring or eligible automatic payments to occur after the next scheduled instance in the bill pay and/or the online payments system are out of the retrieval scope (e.g., such that the rules do not include retrieving these payments). If a payment retrieved from bill pay is a duplicate of a payment otherwise retrieved (e.g., retrieved as a “scheduled” payment), then the rules include removing the bill pay payment record from the retrieved payment records.

In another example, various rules apply to a third database 70 that stores payment records for consumer mortgages. The rules may include (1) retrieving hard-posted payments up to five calendar days preceding the current date. The rules may also include (2) retrieving payments that are processing but have not yet posted to the system of record for the third database 70 (e.g., “pending” payments on the account activity transaction table for the credit account). The rules may additionally include (3) retrieving payments that have not yet started processing. These may include payments that are still held in a bill pay and/or an online payments system (e.g., in a “scheduled” status), as well as payments that are held in the third database 70 and accessed, for example, by the online payments system. The rules may further include (4) retrieving the next instance of a recurring or automatic payment from the bill pay and/or online payments system. In some embodiments, recurring or eligible automatic payments to occur after the next scheduled instance in the bill pay and/or the online payments system are out of the retrieval scope (e.g., the rules do not include retrieving these payments). If a payment retrieved from bill pay is a duplicate of a payment otherwise retrieved, then the rules include removing the bill pay payment record from the retrieved payment records.

In another example, various rules apply to a fourth database 70 that stores payment records for student loan accounts. The rules may include (1) retrieving hard-posted payments up to five calendar days preceding the current date. If retrieval circuit 33 determines that hard-posted payments to a particular sub account are requested, then the rules include retrieving the payments to the sub account. If retrieval circuit 33 determines that hard-posted payments to a particular master account are requested, then the rules include retrieving the payments to the sub accounts associated to the particular master account. The rules may also include (2) retrieving payments that are processing but have not yet posted to the system of record for the fourth database 70 (e.g., “pending” payments on the account activity transaction table for the credit account). If retrieval circuit 33 determines that payments to a particular sub account are requested, then the rules include retrieving payments to the sub account. If retrieval circuit 33 determines payments to a particular master account are requested, then the rules include retrieving payments to the master account. The rules may further include (3) retrieving payments that have not yet started processing are still held in a bill pay system (e.g., in a “scheduled” status). The rules may additionally include (4) retrieving the next instance of any recurring or automatic payments from the bill pay system (e.g., the next instance of a recurring or automatic payment, eBill, etc.). If a payment retrieved from bill pay is a duplicate of a payment otherwise retrieved, then the bill pay payment record is removed from the retrieved payment records.

Accordingly, rules 42-46 may describe which payments records 72 retrieval circuit 33 retrieves from databases 70. The retrieved payment records are passed to filtering circuit 34 and/or comparison circuit 35 for further analysis.

Filtering circuit 34 is communicably coupled to memory 32, retrieval circuit 33, and comparison circuit 35 and is configured to filter one or more payment records 72 and send the payment records 72 to comparison circuit 35 as described in greater detail below. The filtering allows the provider computing system 10 to prepare the retrieved payment records 72 for an exact and potential duplicate matching process, as described in further detail below. Filtering circuit 34 may communicate with second rule database 50 to use rules 52-56 in comparing the one or more retrieved payment records 72.

In one example, various filtering rules apply to payment records retrieved from the first database 70 that stores payment records for consumer cards (e.g., Visa® and American Express®), business direct cards (e.g., Visa® and Mastercard®), personal lines of credit, and retail services credit cards. As an illustration, in some embodiments, the provider computing system 10 does not validate a payment request against automatic payments from the first database 70. Accordingly, a rule for the first database 70 is to filter out automatic payment records retrieved from the first database 70 (e.g., that were set up using an online payments system). In some arrangements, this rule may be applied to prepare a retrieved payment for potential duplicate payment matching (but not exact duplicate payment matching, where this rule is not applied) based on a payment amount (e.g., shown in an “amount” entry) when the payment destination account (e.g., shown in a “to” entry) is a consumer card. This rule may also prepare a retrieved payment for potential duplicate payment matching based on a payment amount when the payment destination amount is business direct, such as a business card, a business line of credit, or a retail services credit card. The potential duplicate matching process is described in further detail below with reference to comparison circuit 35.

In another example, various filtering rules apply to the second database 70 that stores records for home equity accounts, personal credit, and auto loan and/or line-of-credit accounts. As an illustration, in some embodiments, a rule may apply to payment records for home equity accounts retrieved from the second database 70. More specifically, if filtering circuit 34 determines multiple hard-posted payment amounts have been retrieved for a specific day, the rule is to add those amounts together to get a total payment amount for the day that will be used in the duplicate payment matching process. In some arrangements, this rule may be applied to prepare a retrieved payment for potential duplicate payment matching (but not exact duplicate payment matching, where this rule is not applied) based on the payment amount when the payment destination account is a home equity line of credit or home equity loan.

As another illustration, in some embodiments, a rule may apply to payment records for personal lines of credit retrieved from the second database 70. In particular, if filtering circuit 34 determines multiple hard-posted payment amounts are retrieved for a specific day, the rule is to add those amounts together to get a total payment amount for the day that will be used in the duplicate payment matching process. In some arrangements, this rule may be applied to prepare retrieved payments for potential duplicate payment matching (but not exact duplicate payment matching, where this rule is not applied) based on the payment amount when the payment destination account is a personal line of credit or personal loan.

As another illustration, in some embodiments, a rule may apply to payment records for auto loans retrieved from the second database 70. More specifically, if filtering circuit 34 determines multiple hard-posted payment amounts are retrieved for a specific day, the rule is to add those amounts together to get a total payment amount for the day that will be used in the duplicate payment matching process. In some arrangements, this rule may be applied to prepare retrieved payments for potential duplicate payment matching (but not exact duplicate payment matching, where this rule is not applied) based on the payment amount when the payment destination account is an auto loan. For example, the payment destination account may be a business, wholesale, or consumer auto loan account.

In another example, various rules apply to the third database 70 that stores records for mortgage accounts. As an illustration, in some embodiments, if filtering circuit 34 determines multiple hard-posted payment amounts are retrieved for a specific day, the rule is to add those amounts together to get a total payment amount for the day that will be used in the duplicate payment matching process. In some arrangements, this rule may be applied to prepare retrieved payments for potential duplicate payment matching (but not exact duplicate payment matching, where this rule is not applied) based on the payment amount when the payment destination is a mortgage account.

In another example, various rules apply to payment records retrieved from the fourth database 70 that stores records for student loan accounts. As an illustration, in some embodiments, if filtering circuit 34 determines an account is a master student loan account with multiple student loan sub-accounts and if multiple hard-posted payment amounts are retrieved for a specific day, the rule is to add those amounts together to get a total payment amount for the day that will be used in a duplicate payment matching process. Alternatively, if filtering circuit 34 determines an account is a master student loan account with a single student loan sub-account, then no additional filtering is performed. As another illustration, in some embodiments, if filtering circuit 34 determines a co-signer is making a master student loan account payment, then the rule is to filter out any pending payments received; in all other cases, no additional filtering is performed for pending payments. As another illustration, in some embodiments, if filtering circuit 34 determines a customer has a master student loan account with two or more student loan sub-accounts and the customer is making a master student loan account payment, the rule is to filter out scheduled bill pay one-time, recurring, and automatic payments (e.g., scheduled using an “eBill” online functionality) to the student loan sub-account. Alternatively, if filtering circuit 34 determines a customer has a master student loan account with two or more student loan sub-accounts and the customer is making a student loan sub-account payment, the rule is to filter out scheduled bill pay one-time, recurring, and automatic payments (e.g., scheduled using eBill) to the master student loan account. Further, in some arrangements, these rules may prepare retrieved payments for potential duplicate payment matching (but not exact duplicate payment matching, where these rules are not applied) based on the payment amount when the payment destination is a student loan account.

Accordingly, rules 52-56 may describe which payments records 72 filtering circuit 34 passes on to comparison circuit 35 from retrieval circuit 33. The retrieved and filtered payment records are passed to comparison circuit 35 for further analysis. In some embodiments, as indicated in the above examples and illustrations, at least some of rules 52-56 may be applied for a potential duplicate matching process but not an exact duplicate matching process, as described in further detail below. As such, filtering circuit 34 may pass on different sets of payment records to comparison circuit 35 for exact duplicate matching and potential duplicate matching processes.

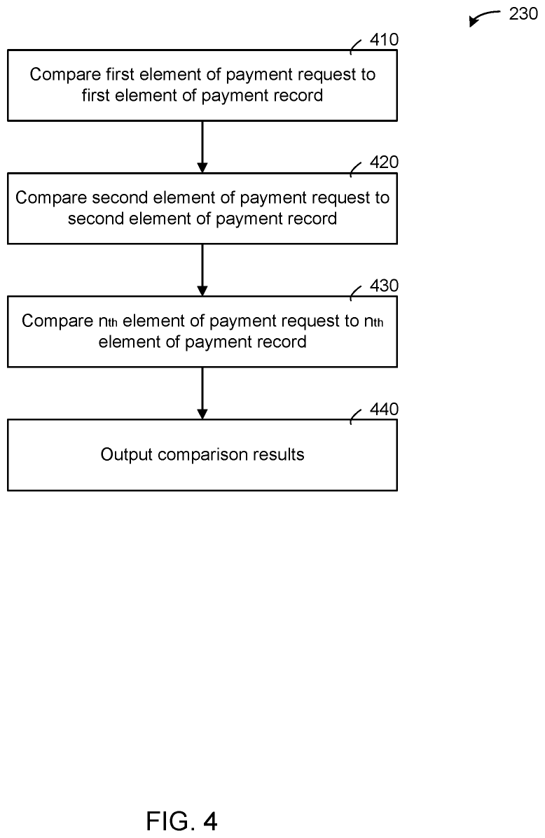

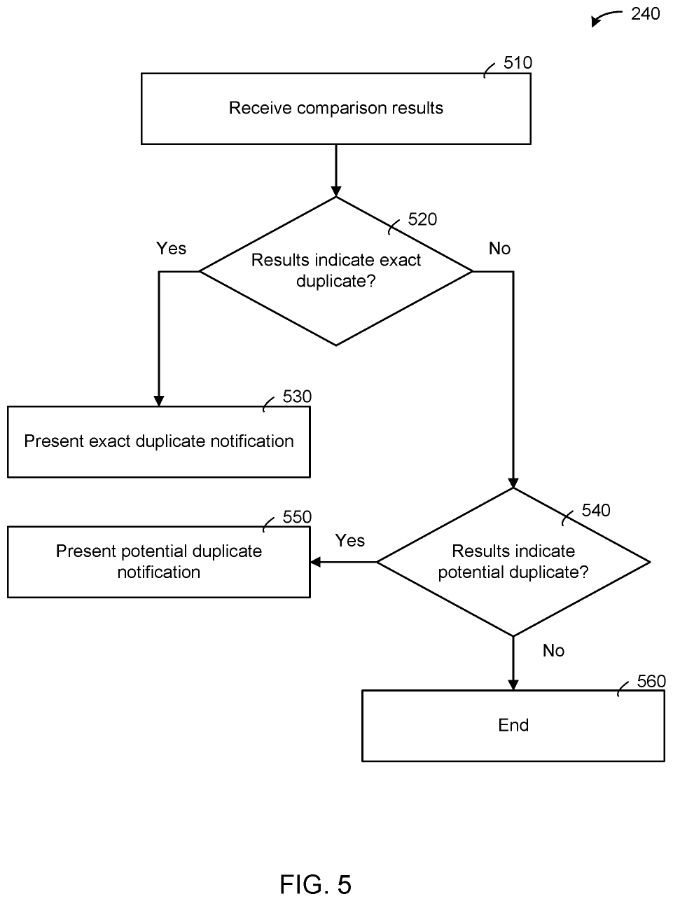

Comparison circuit 35 compares a payment request received from user device 80 to one or more payment records to determine if the payment request is a duplicate payment. Comparison circuit 35 may compare one or more attributes of the payment records to one or more corresponding attributes of the payment request. For example, comparison circuit 35 may compare a payment amount of a retrieved payment record to a payment amount of a payment request to determine if there is a match. In some embodiments, comparison circuit 35 may also be configured to determine near-matches (e.g., a payment amount of a retrieved payment record is within a certain percentage, such as 2%, of a payment amount of the payment request, a payment destination of a retrieved payment record is an alternate spelling or version of a payment destination of the payment request). Comparison circuit 35 may further determine if a payment request is a duplicate payment of more than one retrieved payment record. In some embodiments, comparison circuit 35 may determine if a payment request is an exact duplicate or a potential duplicate as described in detail below with respect to FIGS. 4 and 5. If comparison circuit 35 determines that the user is submitting an exact duplicate or potential duplicate, comparison circuit 35 notifies the user (e.g., by sending a notification to user device 80, which is displayed on display 88).

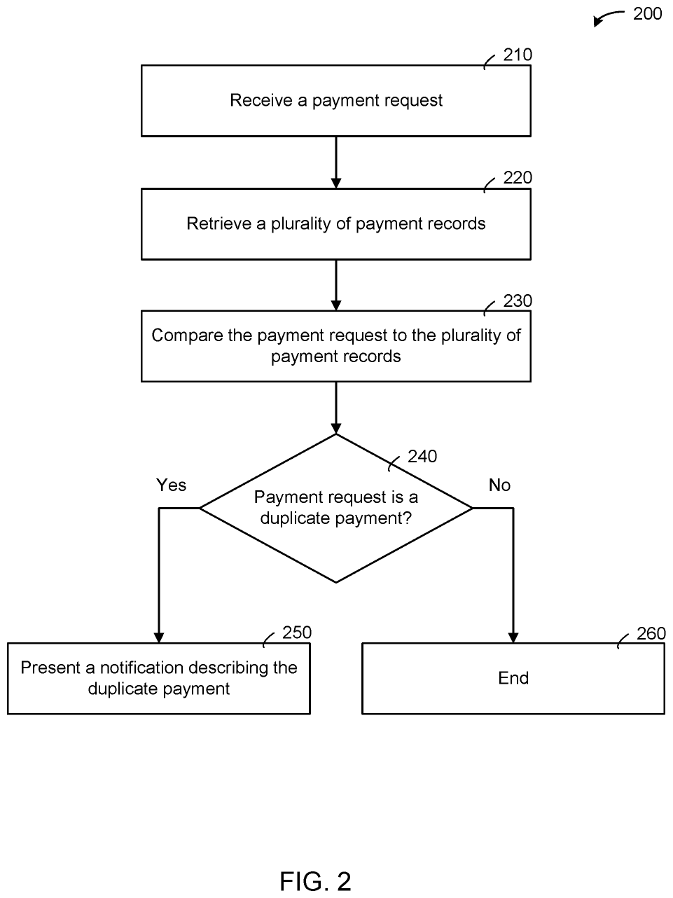

Referring now to FIG. 2, a flow diagram of method 200 to prevent duplicate payments is shown, according to an exemplary embodiment. Method 200 may be configured to include receiving a payment request, detecting a duplicate payment, and in response, presenting a notification. Method 200 may be implemented by system 100 in some embodiments or, in other embodiments, by another system or component altogether. Method 200 is described herein in reference to system 100. However, this is for exemplary purposes and should not be taken as limiting as to specific hardware implementations.

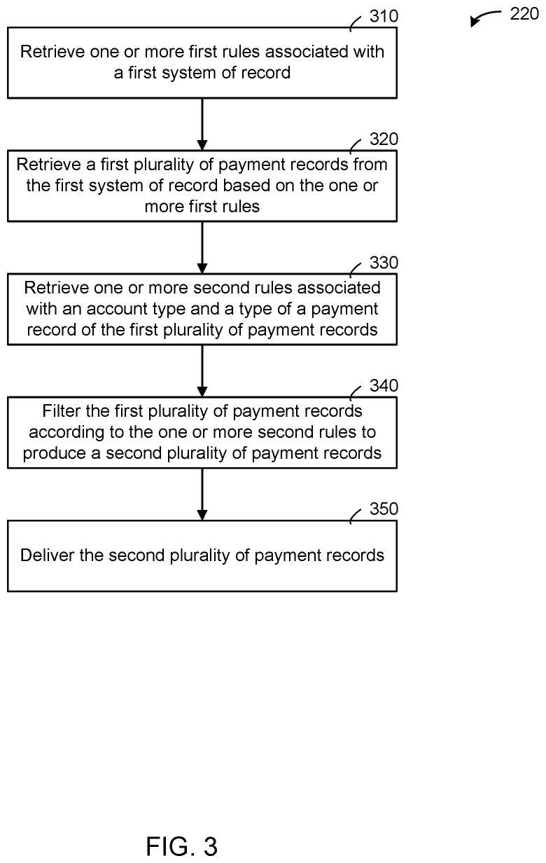

At step 210, provider computing system 10 receives a payment request from a user, for example, via user device 80. The payment request indicates a user's intention to make or schedule a payment for an account that the user holds with the provider. For example, the payment request could be scheduling a rent payment. At step 220, retrieval circuit 33 retrieves a plurality of payment records 72 from databases 70. In various arrangements, retrieval circuit 33 may be configured to use one or more rules 42-46 to retrieve payment records 72. Additionally, filtering circuit 34 may be configured to use one or more rules 52-56 to filter retrieved payment records 72, as described in greater detail with reference to FIG. 3. At step 230, comparison circuit 35 compares the payment request to the retrieved payment records 72.

At step 240, comparison circuit 35 determines if the payment request is a duplicate payment. If the payment request is not a duplicate payment (i.e., the result of step 240 is “No”), then method 200 ends (step 260). If the payment request not a duplicate payment, then the payment request may be processed as normal, and no notification is presented to the user. If the payment request is a duplicate payment (i.e., the result of step 240 is “Yes”), then duplicate payment detection processing circuit 30 may present, via user device 80, a notification describing the duplicate payment (step 250).

Turning now to FIG. 3, a flow diagram of step 220 of retrieving payment records is shown, according to an exemplary embodiment. In some embodiments, retrieval circuit 33 and filtering circuit 34 perform steps 310-350 to retrieve and filter payment records 72 from databases 70. At step 310, retrieval circuit 33 retrieves from first rule database 40 one or more rules 42-46 associated with a first database of databases 70. For example, retrieval circuit 33 may retrieve a rule associated with a student loan records database specifying that only hard-posted payments of up to five days ago will be retrieved. At step 320, retrieval circuit 33 retrieves from the first database of databases 70 a first plurality of payment records 72 based on the one or more rules 42-46. For example, retrieval circuit 33 may retrieve hard-posted payments from up to 5 days ago from the student loan records database.

At step 330, filtering circuit 34 retrieves from second rule database 50 one or more rules 52-56 associated for filtering the retrieved payment records retrieved from the first database 70. In some embodiments, the one or more rules 52-56 may be associated with an account type (e.g., mortgage account, credit card account, student loan account, personal line of credit, etc.) and a type of a payment record (e.g., hard-posted payments, pending payments, scheduled payments, bill pay payments) of the first plurality of payment records 72. For example, filtering circuit 34 may retrieve a rule associated with a student loan records database specifying that if multiple payment amounts are retrieved for a specific day, those amounts should be added together to get a total payment amount for the day that will be used in the potential duplicate payment matching process. At step 340, filtering circuit 34 may apply the one or more rules 52-56 to produce a second plurality of payment records 72. For example, filtering circuit 34 may identify multiple payment amounts retrieved for a specific day and add those amounts together to get a total payment amount for the day that will be used in the potential duplicate payment matching process in step 230, as described in further detail below. As such, the second plurality of payment records 72 may be a filtered subset of the first plurality of payment records 72. In some embodiments, the second plurality of payment records 72 may be different for different comparison processes. For example, filtering circuit 34 may apply one set of rules for payment records used for an exact duplicate matching process and a second set of rules for payment records used for a potential duplicate matching process. At step 350, filtering circuit 34 may send the second plurality of payment records 72 on for further analysis. In some embodiments, filtering circuit 34 may send the second plurality of payments records 72 to comparison circuit 35. Subsequently or concurrently, steps 310-350 are repeated for each database in the databases 70.

Referring now to FIG. 4, a flow diagram of comparing a payment request to a payment record performed as part of step 230 is shown, according to an exemplary embodiment. Comparison circuit 35 may perform steps 410-440 to compare the payment request to each payment record in the retrieved and filtered set of payment records. At step 410, comparison circuit 35 compares a first attribute of the payment request to a first attribute of the payment record. For example, comparison circuit 35 may compare a payment amount for the payment request to a payment amount of the payment record. At step 420, comparison circuit 35 compares a second attribute of the payment request to a second attribute of the payment record. For example, comparison circuit 35 may compare a payment date for the payment request to a payment date of the payment record.

Comparison circuit 35 continues to compare attributes between the payment request and payment record (step 430). For example, comparison circuit 35 may compare a payment destination of the payment request to a payment destination of the payment record. In some embodiments, step 430 continues for as many attributes as are included in the payment request and payment record. In some embodiments, step 430 continues for a predefined number of attributes. At step 440, comparison circuit 35 outputs the comparison results, which are used to identify duplicate payments. For example, comparison circuit 35 may output an indication that the payment request is an exact or potential duplicate of the payment record based on matches between the attributes of the payment request and the payment record. Steps 410-440 are then repeated for each payment record of the retrieved and filtered payment records (e.g., the second plurality of payment records from FIG. 3). In some embodiments, comparison circuit 35 may compare different sets of payment records to the payment request based on whether comparison circuit 35 is determining an exact duplicate or a potential duplicate, as described in further detail below with reference to FIG. 5. For example, comparison circuit 35 may compare the entirety of the retrieved payment records (e.g., the first plurality of payment records in step 220) in performing an exact duplicate determination and compare a filtered subset of the retrieved payment records (e.g., the second plurality of payment records in step 220). As another example, comparison circuit 35 may compare different sets of filtered payment records (e.g., filtered using different sets of rules) in performing exact duplicate and potential duplicate determinations.

Referring now to FIG. 5, a flow diagram of step 240 of determining a duplicate payment is shown, according to an exemplary embodiment. At step 510, comparison circuit 35 receives the comparison results (e.g., outputted in step 440 of FIG. 4). In some embodiments, step 510 represents results being passed from one function to another within comparison circuit 35. At step 520, comparison circuit 35 analyzes the results to determine if the payment request is an exact duplicate. In some embodiments, an exact duplicate is a payment request with matching user account, payment date, payment amount, payment source, and payment destination attributes to the attributes of a payment record. However, it should be understood that in other embodiments, an exact duplicate may have a different type, number, or combination of matching attributes.

If comparison circuit 35 identifies that the payment request is an exact duplicate (i.e., the result of step 520 is “Yes”), then duplicate payment detection processing circuit 30 presents, via user device 80, an exact duplicate notification to the user (step 530). For example, duplicate payment detection processing circuit 30 may interface with user device 80 and present the exact duplicate notification to the user via a website that the user is using to submit the payment request (e.g., an online banking portal) or via a mobile application that the user is using to submit the payment request (e.g., a mobile banking application). The exact duplicate notification may be presented, for example, as a splash page or as a pop-up notification as part of the website or mobile application. In some embodiments, system 100 may prevent the user from submitting an exact duplicate payment request. As an example, the duplicate payment detection processing circuit 30 may provide a user interface to user device 80 indicating that the user cannot proceed with the payment request without changing at least one attribute of the payment request. The user interface includes buttons that the user can press to indicate either that the user wishes to cancel the payment request or to modify the payment request.

If the payment request is not an exact duplicate (i.e., the result of step 520 is “No”), then comparison circuit 35 analyzes the comparison results to determine if the payment request is a potential duplicate (step 540). In some embodiments, a potential duplicate is a payment request with matching payment amount and payment destination attributes to the attributes of one of the retrieved and filtered payment records. However, it should be understood that in other embodiments, a potential duplicate may have a different type, number, or combination of attributes. In some embodiments, a payment request may be a potential duplicate of multiple payment records.

If comparison circuit 35 identifies that the payment request is a potential duplicate (i.e., the result of step 540 is “Yes”), then duplicate payment detection processing circuit 30 presents, via user device 80, a potential duplicate notification to the user (step 550). For example, duplicate payment detection processing circuit 30 may present the potential duplicate notification to the user similarly to the exact duplicate notification, such as via a website or a mobile application that the user is using to submit the payment request. The potential duplicate notification may be presented, for example, as a splash page or as a pop-up notification. In some embodiments, duplicate payment detection processing circuit 30 presents multiple potential duplicate notifications to the user simultaneously. In some embodiments, duplicate payment detection processing circuit 30 presents multiple notifications hierarchically, as described in greater detail below. If the payment request is not a potential duplicate (i.e., the result of step 540 is “No”), method 200 ends, and no notification is displayed (step 560).

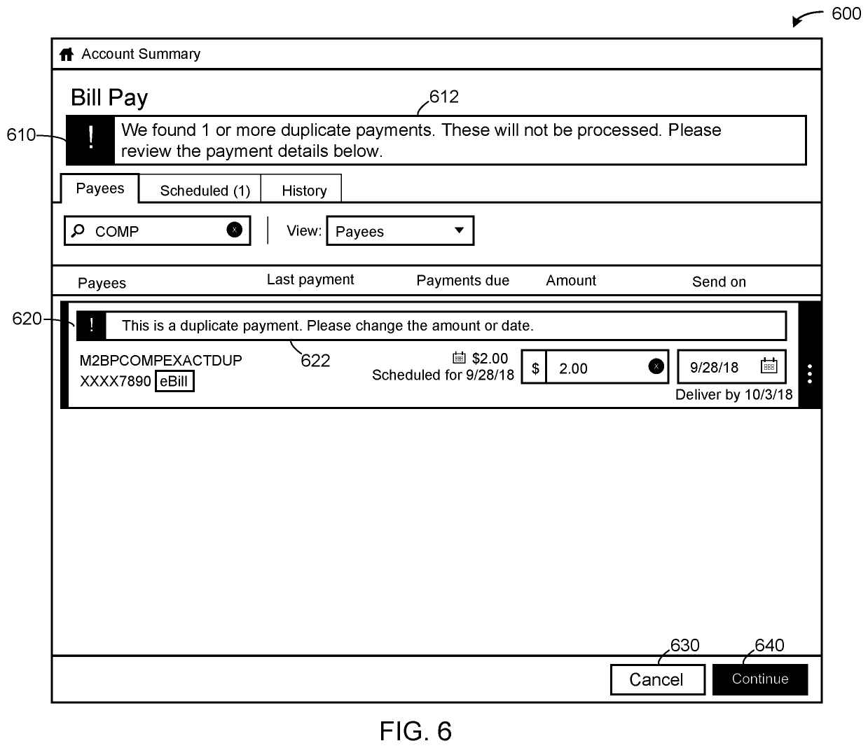

Referring now to FIG. 6, notification 600 for an exact duplicate payment is shown, according to an exemplary embodiment. Notification 600 may be presented to a user by system 100 via display 88 of user device 80. Notification 600 may be presented in response to method 200 as described in detail with reference to FIG. 2. For example, the user may submit a one-time payment request via an online banking portal, and in response, notification 600 may be shown to the user as part of the online banking portal (e.g., as part of the payment request page, as a splash page, etc.). In some embodiments, notification 600 is presented in response to detecting an exact duplicate as described in detail with reference to FIG. 5 above. Notification 600 alerts a user that a payment request is a duplicate payment request. Further, in some embodiments, notification 600 may require a user to alter the payment request before it can be submitted.

As shown in FIG. 6, notification 600 may include overview 610, duplicate payment 620, and one or more inputs 630 and 640. Overview 610 may provide a user with a high-level summary of notification 600. In some embodiments, overview 610 may be located such that it is highly and immediately visible to a user. For example, overview 610 may be located at the top of notification 600 or may be highlighted, bolded, brightly colored, or otherwise emphasized. Overview 610 may include details 612 that describe the reason for notification 600 and any potential action the user may be required to take before provider computing system 10 will process the payment request. In some embodiments, details 612 include a text string, “We found 1 or more duplicate payments. These will not be processed. Please review the payment details below.” However, it should be understood that this message is exemplary and that in other embodiments, details 612 may include a different type and/or content of descriptor.

As shown in FIG. 6, duplicate payment 620 may indicate which payment request is a duplicate payment. Duplicate payment 620 may be formatted such that a user is drawn to look at it following overview 610. For example, overview 610 and duplicate payment 620 could both be red colored, and duplicate payment 620 could be of a smaller size to indicate secondary importance. In some embodiments, the look of the duplicate payment request shown as part of notification 600 may be modified from, for example, a previous screen in which the user submitted the duplicate payment request to indicate which attributes are duplicates. For example, a matching payment amount and payment date to that of a previously submitted payment record may be shown in a red color. Duplicate payment 620 may also include details 622. Details 622 may describe the specific attributes of the payment request deemed to be duplicative and any potential action a user may be required to take. In some embodiments, details 622 includes a text string, “This is a duplicate payment. Please change the amount or date.” However, it should be understood that this message is exemplary and that in other embodiments, details 622 may include a different type and/or content of descriptor.

One or more inputs 630 and 640 may be configured to receive user input indicating compliance with notification 600. For example, notification 600 may require a user to change one or more attributes of a payment request before submittal (e.g., the payment amount or date). In some embodiments, inputs 630 and 640 include a “cancel” (shown as input 630 in FIG. 6) and a “continue” (shown as input 640 in FIG. 6) option to cancel the current payment request or submit a current payment request respectively. Continuing the example, prior to a change of the one or more attributes, inputs 630 and/or 640 may be grayed out or otherwise inoperable to indicate to a user that they must change the one or more attributes to continue. As an illustration, input 630 may be selectable by the user, but input 640 may not be selectable by the user until the user has changed the one or more attributes.

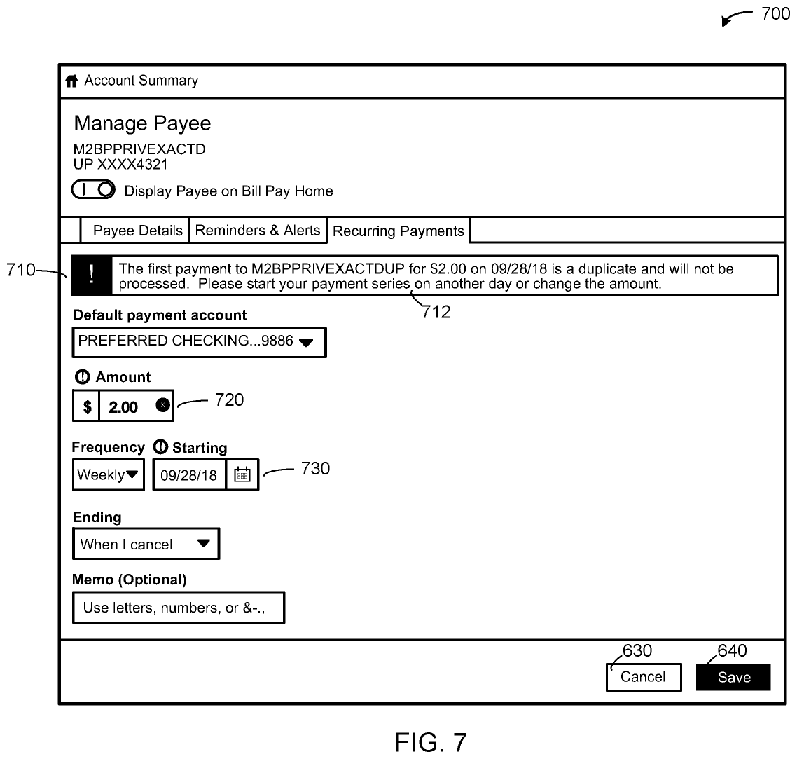

Turning now to FIG. 7, notification 700 for an exact duplicate payment is shown, according to an exemplary embodiment. Notification 700 may be presented to a user by system 100 via display 88 of user device 80. Notification 700 may be presented in response to method 200 as described in detail with reference to FIG. 2. For example, the user may submit a recurring payment request via an online banking portal, and in response, notification 700 may be shown to the user as part of the online banking portal (e.g., as part of the payment request page, as a splash page, etc.). In some embodiments, notification 700 is presented in response to detecting an exact duplicate as described in detail with reference to FIG. 5 above. Notification 700 alerts a user that a payment request is a duplicate payment request. In some embodiments, notification 700 may also require a user to alter the payment request before it can be submitted.

Notification 700 may include overview 710, duplicate payment request attributes 720 and 730, and one or more inputs 630 and 640. Overview 710 may be configured similarly to overview 610 and may provide a user with a high-level summary of notification 700. Overview 710 may also include details 712 describing the reasons for notification 700 and any potential action the user may be required to take before provider computing system 10 will process the payment request. In some embodiments, details 712 may include a text string, “The first payment to [payment destination] for [payment amount] on [payment date] is a duplicate payment and will not be processed. Please start your payment series on another day or change the amount.” However, it should be understood that in other embodiments, details 712 may include a different type and/or content of descriptor.

In some embodiments, duplicate payment request attributes 720 and 730 may indicate which attributes of the payment request included in notification 700 are duplicate attributes. For example, a payment amount and a recurring payment start date may be formatted as duplicate payment request attributes 720 and 730 by displaying in a red color. In some embodiments, duplicate payment request attributes 720 and 730 may display a graphic, display text in bold, or otherwise indicate a duplicate status. For example, duplicate payment request attributes 720-730 may display a red exclamation mark next to the attribute, as shown in FIG. 7. In some embodiments, notification 700 may include one or more inputs 630 and 640 as similar to those described above with reference to FIG. 6.

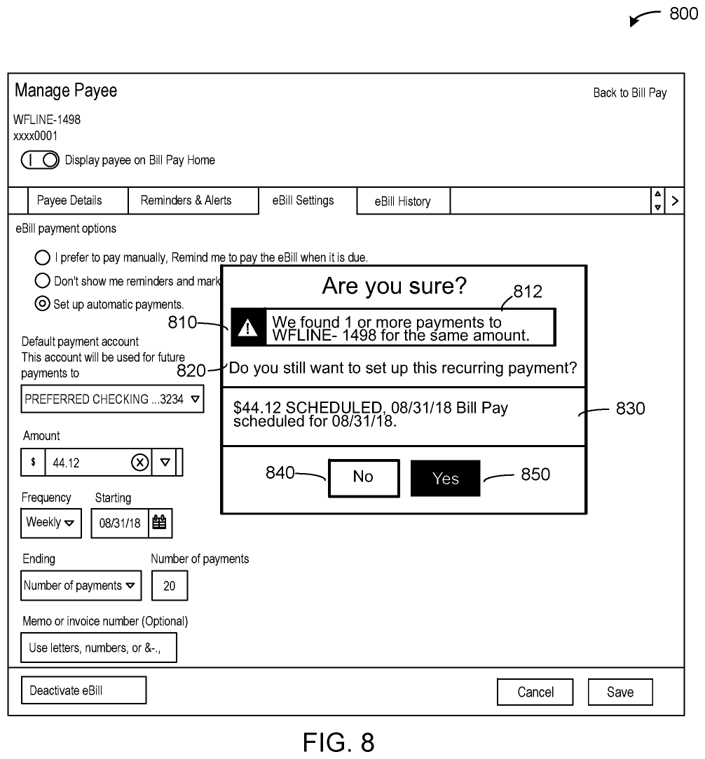

Referring now to FIG. 8, notification 800 for a potential duplicate payment is shown, according to an exemplary embodiment. Notification 800 may be presented to a user by system 100 via display 88 of user device 80. Notification 800 may be presented in response to method 200 as described in detail with reference to FIG. 2. For example, the user may submit a recurring payment request via an online banking portal, and in response, notification 800 may be shown to the user as part of the online banking portal (e.g., as a pop-up notification). In some embodiments, notification 800 is presented in response to detecting a potential duplicate payment as described in detail with reference to FIG. 5 above. Notification 800 alerts a user that a payment request is a duplicate payment request.

Notification 800 may include overview 810, prompt 820, details 830 and one or more inputs 840-850. Overview 810 may provide a user with a high-level summary of the notification. Overview 810 may also include details 812 describing the reasons for notification 800 and, in some embodiments, a potential action the user may be required to take before the payment request will be processed by provider computing system 10. In some embodiments, details 812 may include a text string, “We found 1 or more payments to [payment destination] for the same amount.” However, it should be understood that in other embodiments, details 812 may include a different type and/or content of descriptor. Similar to overview 610, overview 810 may be located at the top of notification 800 or otherwise formatted or disposed on notification 800 so as to be of primary visual importance.

Prompt 820 may query the user regarding the payment request. In some embodiments, prompt 820 may include a text string, “Do you still want to set up this recurring payment?” In other embodiments, prompt 820 may include a different text string or may otherwise vary depending on the type of payment request a user is attempting to set up. Details 830 may provide specific information relating to the duplicate payment. For example, details 830 may describe the attributes of the payment request considered to be duplicative as well as the attributes of the corresponding duplicate payment record. In some embodiments, details 830 include a text string, “[payment amount] [payment type], [payment date] [payment scheduler] scheduled for [payment date].” However, it should be understood that in other embodiments, details 830 includes a different type and/or content of descriptor. For example, details 830 may change based on the type of payment request and type of payment record.

One or more inputs 840 and 850 may be configured to receive user input and indicate compliance with notification 800. In some embodiments, inputs 840 and 850 correspond to prompt 820. For example, if prompt 820 is a yes or no question, inputs 840 and 850 may be “No” and “Yes,” respectively. In some embodiments, inputs 840 and 850 may close or otherwise modify notification 800. In some embodiments, input 840 may close notification 800 and allow a user to modify the payment request. In some embodiments, input 850 may submit the payment request as is to provider computing system 10.

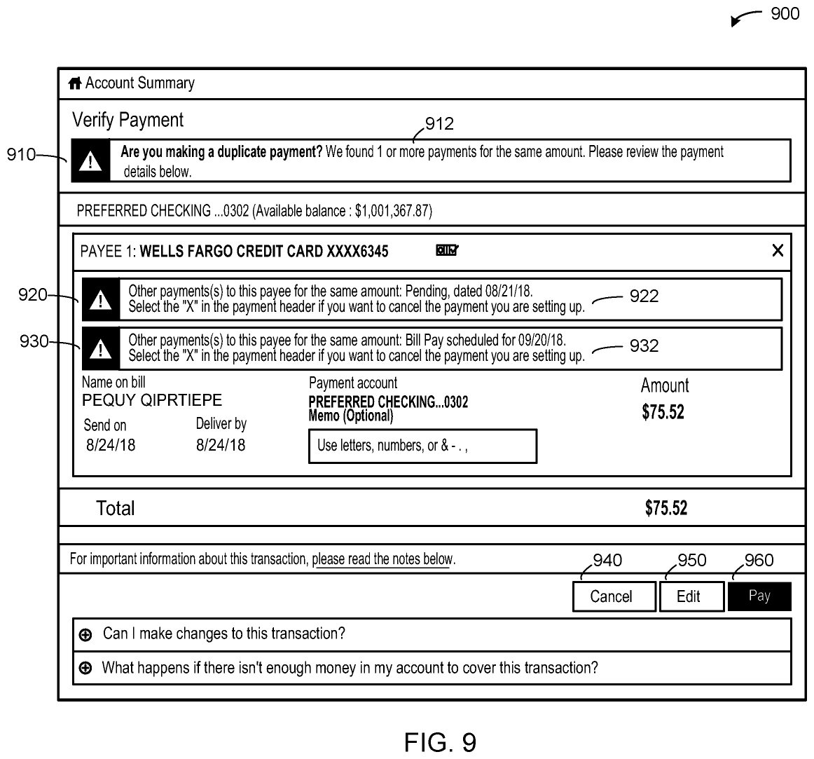

Referring now to FIG. 9, notification 900 for a potential duplicate payment is shown, according to an exemplary embodiment. Notification 900 may be presented to a user by system 100 via display 88 of user device 80. Notification 900 may be presented in response to method 200 as described in detail with reference to FIG. 2. For example, the user may submit a one-time payment request via an online banking portal, and in response, notification 900 may be shown to the user as part of the online banking portal (e.g., as a splash page). In some embodiments, notification 900 is presented in response to detecting a potential duplicate as described in detail with reference to FIG. 5 above. Notification 900 alerts a user that a payment request is a duplicate payment request.

Notification 900 may include overview 910, one or more duplicate payment records 920-930, and one or more inputs 940-960. Overview 910 may provide a user with a high-level summary of the notification. Overview may also include details 912 to describe notification 900 and any potential action a user may be required to take before the payment request will be processed by provider computing system 10. In some embodiments, details 912 may include a text string, “Are you making a duplicate payment? We found 1 or more payments for the same amount. Please review the payment details below.” However, it should be understood that in other embodiments, details 912 may include a different type and/or content of descriptor. Overview 910 may be located at the top of notification 900 or otherwise formatted or disposed on notification 900 so as to be of primary visual importance.

Duplicate payment records 920 and 930 may indicate which one or more payment records the current payment request is a duplicate of. There may be as many duplicate payment records as there are payment records matching the payment request. For example, if a payment request is a duplicate payment of four payment records, then four duplicate payment records may be shown in notification 900. In the embodiment of FIG. 9, there are two duplicate payment records 920 and 930. In some embodiments, duplicate payment records are displayed hierarchically such that the oldest payment record is shown first, as illustrated by duplicate payment records 920 and 930 in FIG. 9. In some embodiments, duplicate payment records are grouped by payment type or are organized in another fashion. In some embodiments, duplicate payment records include details 922 and 932, respectively. Details 922 and 932 may describe the specific attributes of the payment request deemed to be duplicative and any potential action a user may be required to take. In some embodiments, details 922 includes a text string, “Other payment(s) to this payee for the same amount: [payment type], dated [payment date]. Select the ‘X’ in the payment header if you want to cancel the payment you are setting up.” Similarly, details 932 includes a text string, “Other payment(s) to this payee for the same amount [payment type] scheduled for [payment date. Select the ‘X’ in the payment header if you want to cancel the payment you are setting up.” However, it should be understood that in other embodiments, details 922 and 932 may include different types and/or contents of descriptors and may vary based on a payment type of the payment request or payment record.

One or more inputs 940-960 may be configured to receive user input. In some embodiments, inputs 940-960 may close or otherwise modify notification 900. In some embodiments, input 940 may cancel the current payment request. For example, input 940 may close notification 900 and redirect the user to an account overview page. In some embodiments, input 950, may allow a user to edit details of the current payment request. For example, input 950 may close notification 900 and redirect the user to a payment request page. In some embodiments, input 960 submit the current payment request. For example, input 960 may ignore notification 900 and submit the current payment request as is to provider computing system 10. As such, in some embodiments, inputs 940-960 may allow the user to ignore notification 900 and submit the duplicate payment.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for”.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (“IC”), discrete circuits, system on a chip (“SOC”) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (“ASICs”), field programmable gate arrays (“FPGAs”), digital signal processors (“DSPs”), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a computing system in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), a distributed ledger (e.g., a blockchain), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data that cause a general purpose computer, a special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should be understood that a “network interface,” as used herein, includes any of a cellular transceiver (e.g., Code Division Multiple Access (“CDMA”), Global System for Mobile Communications (“GSM”), Long-Term Evolution (“LTE”), etc.), a wireless network transceiver (e.g., 802.11X, ZigBee, or Bluetooth), an external network device (e.g., computer port, network interface card (“NIC”), network socket, port), or a combination thereof (e.g., both a cellular transceiver and a Bluetooth transceiver). In some arrangements, a network interface includes hardware and machine-readable media sufficient to support communication over multiple channels of data communication. Further, in some arrangements, the network interface includes cryptography capabilities to establish a secure, or relatively secure, communication session between provider computing system 10 including network interface 20, user device 80 including network interface 86, and other devices of the system 100 via the network 60. In this regard, personal information about clients, financial data, and other types of data is encrypted and transmitted to prevent, or substantially prevent, the threat of hacking.

It should also be noted that the term “input devices” or “input components,” as described herein, may include any type of input device including, but not limited to, a keyboard, a keypad, a mouse, joystick or other input devices performing a similar function. Comparatively, the term “output device” or “output component,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Ethereum, Ripple, Litecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system for detecting duplicate payments, comprising:
a network interface configured to securely communicate, via a network during a secure encrypted communication session, with a provider computing system and a user device, the provider computing system associated with an accounts provider and the user device associated with a user holding one or more accounts with the accounts provider; and
a processing circuit comprising a memory, at least one processor, a filtering circuit, and a comparison circuit, the memory storing instructions that are executable by the at least one processor to:
provide a user interface to a display device of the user device associated with the user, the user interface to receive a first payment attribute via a first user input, a second payment attribute via a second user input, and a third user input selecting an input option to submit a payment request corresponding to the first payment attribute and the second payment attribute;
establish, via the network interface, a secure encrypted communication session with the user device;
receive, from the user device via the secure encrypted communication session, the first payment attribute associated with the first user input and a second payment attribute associated with the second user input, the first user input and the second user input indicating the user's desire to transfer funds from an account held by the user with the accounts provider, wherein receiving the first payment attribute and the second payment attribute occurs prior to receiving the third user input to submit the payment request and does not comprise submitting the payment request to the provider computing system for processing over the network;
retrieve, based on receiving at least one of the first payment attribute and the second payment attribute, a subset of a plurality of first rules to apply to a first database to retrieve a first plurality of payment records, the subset of the plurality of first rules varying according to an account type associated with a first requested payment records, wherein the first plurality of payment records is a subset of payment records stored in the first database;
selectively retrieve, based on the retrieved subset of the plurality of first rules, the first plurality of payment records from a first database associated with the provider computing system by applying at least a first rule to retrieve processed payments, a second rule to retrieve pending payments, and a third rule to retrieve scheduled payments, wherein the plurality of first rules are specific to the first database;
perform, by the comparison circuit, a first comparison to determine if the first payment attribute and the second payment attribute represent an exact duplicate payment request, wherein performing the first comparison comprises comparing the first payment attribute and the second payment attribute to one or more attributes of each of the retrieved first plurality of payment records;
retrieve, based receiving on at least one of the first payment attribute and the second payment attribute and in response to determining that the first payment attribute and the second payment attribute do not represent an exact duplicate payment request, a subset of a plurality of second rules to apply to a second database that is external to the provider computing system to retrieve a second plurality of payment records, the subset of the plurality of second rules varying according to an account type associated with a second requested payment record, wherein the second plurality of payment records is a subset of payment records stored in the second database;
selectively retrieve, via a second secure encrypted communication session with the second database based on the retrieved subset of the plurality of second rules, the second plurality of payment records from the second database by applying at least a fourth rule to retrieve future recurring payments, wherein the plurality of second rules are specific to the second database and different from the plurality of first rules;
filter, by the filtering circuit, based on a type of payment record in accordance with the subset of the plurality of second rules, the second plurality of payment records to exclude one or more payment records from the second plurality of payment records, wherein the type of payment record comprises at least one of a one-time payment, recurring payment, or automatic payment;
produce, by the filtering circuit, a subset of the filtered second plurality of payment records for a second comparison including an aggregated payment record, wherein the subset of the filtered second plurality of payment records is produced by:
determining that two or more payment records of the filtered second plurality of payment records are associated with a given time period, wherein each payment record of the subset has a respective payment amount; and
producing the aggregated payment record by aggregating the respective payment amounts of the two or more payment records of the filtered second plurality of payment records associated with the time period to create a total payment amount for the two or more payment records of the filtered second plurality of payment records, wherein the total payment amount of the aggregated payment record does not match a single payment record stored on the second database;
transmit, from the filtering circuit to the comparison circuit, the produced subset of the filtered second plurality of payment records, wherein the produced subset of the filtered second plurality of payment records includes fewer payment records than the second plurality of payment records or the filtered second plurality of payment records;
perform, by the comparison circuit, a second comparison, wherein performing the second comparison comprises comparing the first payment attribute and the second payment attribute to one or more attributes of the subset of the filtered second plurality of payment records, wherein at least a first of the one or more attributes of the subset of the filtered second plurality of payment records comprises an aggregated payment amount, and wherein at least a second of the one or more attributes of the subset of the filtered second plurality of payment records comprises a type of the payment record;
determine, based on the second comparison, that the first payment attribute or the second payment attribute represent a potential duplicate payment request with the aggregated payment record;
in response to determining that the first payment attribute or the second payment attribute represent a potential duplicate payment request with the aggregated payment record, provide to the user, via the user interface provided to the display device of the user device, a pop-up notification describing the aggregated payment record, the potential duplicate payment request, and a specific payment attribute causing a potential duplicate condition, the pop-up notification comprising the input option to submit the payment request that is temporarily unselectable and grayed out to indicate to the user the user must change one or more of the first payment attribute and the second payment attribute to submit the payment request, wherein the input option is inoperable until a user input altering the first payment attribute via a first editable field or the second payment attribute via a second editable field is received within the pop-up notification;
receive, from the user via the user interface provided to the display device, a user input altering the first payment attribute or the second payment attribute within the pop-up notification, wherein the user input altering the first payment attribute or the second payment attribute alters the payment request such that the payment request is not a potential duplicate payment request with the aggregated payment record;
allow, based on the received user input, the user to select the input option to submit the payment request within the pop-up notification; and
submit, by the network interface based on the user input selecting the input option, the payment request to the provider computing system.

2. The system of claim 1, the memory further storing instructions that are executable by the at least one processor to:
determine a total payment amount of a time interval by adding a first payment amount of a first payment record of the first plurality of payment records associated with the time interval to a second payment amount of a second payment record of the first plurality of payment records associated with the time interval,
wherein the first comparison is performed using the determined total payment amount, wherein the determined total payment amount is not associated with a single payment record of the first plurality of payment records.

3. The system of claim 1, wherein each of the first plurality of payment records is associated with a processed payment, a pending payment, or a scheduled payment.

4. The system of claim 1, wherein the first payment attribute and the second payment attribute include at least one of a payment funding account, a payment date, a payment amount, a payment source, and a payment destination, wherein performing the first comparison comprises comparing the first payment attribute and the second payment attribute to at least a payment funding account, a payment date, a payment amount, a payment source, and a payment destination of each of the retrieved first plurality of payment records.

5. The system of claim 4, wherein the instructions cause the system to determine that the first payment attribute or the second payment attribute represent an exact duplicate in response to the first comparison comprising matches between the payment funding account, the payment date, the payment amount, the payment source, and the payment destination of the payment request and a payment record.

6. The system of claim 5, wherein the pop-up notification comprises a second input option configured to cancel the payment request.

7. The system of claim 1, wherein the first payment attribute and the second payment attribute include at least one of a payment amount and a payment destination, wherein performing the second comparison comprises comparing at least the first payment attribute and the second payment attribute to at least a payment amount and a payment destination of each of the subset of the filtered second plurality of payment records.

8. The system of claim 7, wherein the instructions cause the system to determine that the first payment attribute or the second payment attribute represent is a potential duplicate in response to the second comparison comprising matches between the first payment attribute or the second payment attribute and the payment amount and the payment destination of at least one payment record.

9. The system of claim 8, wherein the pop-up notification comprises a second input option configured to cancel the payment request.

10. The system of claim 1, wherein performing the first comparison comprises comparing the first payment attribute and the second payment attribute to one or more attributes of each of the retrieved first plurality of payment records, and wherein performing the second comparison comprises comparing the first payment attribute and the second payment attribute to one or more attributes of each of the subset of the filtered second plurality of payment records.

11. (canceled)

12. The system of claim 1, wherein the instructions further cause the system to, in response to determining that the first payment attribute and the second payment attribute represent is a duplicate payment request with more than one payment record, display the more than one payment record hierarchically within the pop-up notification.

13. A method of detecting duplicate payments, the method comprising:
providing a user interface to a display device of a user device associated with a user, the user interface to receive a first payment attribute via a first user input, a second payment attribute via a second user input, and a third user input selecting an input option to submit a payment request corresponding to the first payment attribute and the second payment attribute;
establishing, via a network interface, a secure encrypted communication session with the user device over a network, the network interface to communicate with a provider computing system and the user device via a cryptographic method, the provider computing system including a memory, at least one processor, a filtering circuit, and a comparison circuit, the memory storing instructions that are executable by the at least one processor;
receiving, from the user device via the secure encrypted communication session, the first payment attribute associated with the first user input and a second payment attribute associated with the second user input, the first user input and the second user input indicating the user's desire to transfer funds from an account held by the user with an accounts provider, wherein receiving the first payment attribute and the second payment attribute occurs prior to receiving the third user input to submit the payment request and does not comprise submitting the payment request to a provider computing system for processing over the network;
retrieving, based on receiving at least one of the first payment attribute and the second payment attribute, a subset of a plurality of first rules to apply to a first database to retrieve a first plurality of payment records, the subset of the plurality of first rules varying according to an account type associated with a first requested payment records, wherein the first plurality of payment records is a subset of payment records stored in the first database;
selectively retrieving, based on the retrieved subset of the plurality of first rules, a first plurality of payment records from a first database associated with the provider computing system by applying at least a first rule to retrieve processed payments, a second rule to retrieve pending payments, and a third rule to retrieve schedule payments, wherein the plurality of first rules are specific to the first database;
performing, by the comparison circuit of the provider computing system, a first comparison to determine if the first payment attribute and the second payment attribute represent an exact duplicate payment request, wherein performing the first comparison comprises comparing the first payment attribute and the second payment attribute to one or more attributes of each of the retrieved first plurality of payment records;
retrieving, based receiving on at least one of the first payment attribute and the second payment attribute and in response to determining that the first payment attribute and the second payment attribute do not represent an exact duplicate payment request, a subset of a plurality of second rules to apply to a second database that is external to the provider computing system to retrieve a second plurality of payment records, the subset of the plurality of second rules varying according to an account type associated with a second requested payment record, wherein the second plurality of payment records is a subset of payment records stored in the second database;
selectively retrieving, via a second secure encrypted communication session with the database based on the retrieved subset of the second plurality of second rules, the second plurality of payment records from the second database by applying at least a fourth rule to retrieve future payments, wherein the plurality of second rules are specific to the second database and different from the plurality of first rules;
in response to determining that the first payment attribute and the second payment attribute do not represent an the exact duplicate payment request, filtering, by the filtering circuit of the provider computing system and based on a type of payment record in accordance with the plurality of second rules, the second plurality of payment records to exclude one or more payment records from the second plurality of payment records, wherein the type of payment record comprises at least one of a one-time payment, recurring payment, or automatic payment;
producing by the filtering circuit of the provider computing system, a subset of the filtered second plurality of payment records for a second comparison including an aggregated payment record, wherein the subset of the filtered second plurality of payment records is produced by:
determining that two or more payment records of the filtered second plurality of payment records are associated with a given time period, wherein each payment record of the subset has a respective payment amount; and
producing the aggregated payment record by aggregating the payment amounts of the two or more payment records of the filtered second plurality of payment records associated with the time period to create a total payment amount for the two or more payment records of the filtered second plurality of payment records, wherein the total payment amount of the aggregated payment record does not match a single payment record stored on the second database;
transmitting, from the filtering circuit of the provider computing system to the comparison circuit of the provider computing system, the produced subset of the filtered second plurality of payment records, wherein the produced subset of the filtered second plurality of payment records includes fewer payment records than the second plurality of payment records or the filtered second plurality of payment records;
performing, by the comparison circuit of the provider computing system, a second comparison, wherein performing the second comparison comprises comparing the first payment attribute and the second payment attribute to one or more attributes of the subset of the filtered second plurality of payment records, wherein at least a first of the one or more attributes of the subset of the filtered second plurality of payment records comprises an aggregated payment amount, and wherein at least a second of the one or more attributes of the subset of the filtered second plurality of payment records comprises a type of the payment record;
determining, based on the second comparison, if the first payment attribute or the second payment attribute represent is a duplicate payment request with the aggregated payment record;
in response to determining that the first payment attribute or the second payment attribute represent is a potential duplicate payment request, providing to the user, via the user interface provided to the display device of the user device, a pop-up notification describing the aggregated payment record, the potential duplicate payment request, and a specific payment attribute causing a potential duplicate condition, the pop-up notification comprising the input option to submit the payment request that is temporarily unselectable and grayed out to indicate that the user must change one or more of the first payment attribute and the second payment attribute to submit the payment request, wherein the input option is inoperable until a user input altering the first payment attribute via a first editable field or the second payment attribute via a second editable field is received within the pop-up notification;
receiving, from the user via the user interface provided to the display device, a user input altering the first payment attribute or the second payment attribute within the pop-up notification, wherein the user input altering the first payment attribute or the second payment attribute alters the payment request such that the payment request is not a potential duplicate payment request of the aggregated payment record;
allowing, based on the received user input, the user to select the input option to submit the payment request within the pop-up notification;
submitting, by the network interface based on the user input selecting the input option, the payment request to the provider computing system.

14. The method of claim 13 further comprising:
determining a total payment amount of a time interval by adding a first payment amount of a first payment record of the first plurality of payment records associated with the time interval to a second payment amount of a second payment record of the first plurality of payment records associated with the time interval,
wherein the first comparison is performed using the determined total payment amount, wherein the determined total payment amount is not associated with a single payment record of the first plurality of payment records.

15. The method of claim 13, wherein each of the first plurality of payment records is associated with a processed payment, a pending payment, or a scheduled payment.

16. The method of claim 13, wherein the first payment attribute and the second payment attribute include at least one of a payment funding account, a payment date, a payment amount, a payment source, and a payment destination, wherein performing the first comparison comprises comparing the first payment attribute and the second payment attribute to at least a payment funding account, a payment date, a payment amount, a payment source, and a payment destination of each of the retrieved first plurality of payment records or the filtered first plurality of payment records.

17. The method of claim 13, wherein the first payment attribute and the second payment attribute include at least one of a payment amount and a payment destination, wherein performing the second comparison comprises comparing the first payment attribute and the second payment attribute to at least a payment amount and a payment destination of the subset of the filtered second plurality of payment records.

18. The method of claim 13, wherein the first payment attribute or the second payment attributer represent a duplicate payment request with more than one payment record, and wherein the method further comprises displaying the more than one payment record hierarchically within the pop-up notification.

19. The method of claim 13, wherein performing the first comparison comprises comparing the first payment attribute and the second payment attribute to one or more attributes of each of the retrieved first plurality of payment records, and wherein performing the second comparison comprises comparing the first payment attribute and the second payment attribute to one or more attributes of each of the subset of the filtered second plurality of payment records.

20. (canceled)

21. A duplicate payment detection system, comprising:
a network interface configured to communicate, via a network during an encrypted communication session, with a provider computing system and a user device, the provider computing system associated with an accounts provider and the user device associated with a user holding one or more accounts with the accounts provider; and
a processing circuit comprising a memory, at least one processor, a filtering circuit, and a comparison circuit the memory storing instructions that are executable by the at least one processor to:
provide a user interface to a display device of the user device associated with the user, the user interface to receive a first payment attribute via a first user input, a second payment attribute via a second user input, and a third user input selecting an input option to submit a payment request corresponding to the first payment attribute and the second payment attribute;
establish, via the network interface, a secure encrypted communication session with the user device;
receive, from the user device via the secure encrypted communication session, the first payment attribute associated with the first user input and a second payment attribute associated with the second user input, the first user input and the second user input indicating the user's desire to transfer funds from an account held by the user with the accounts provider, wherein receiving the first payment attribute and the second payment attribute occurs prior to receiving the third user input to submit the payment request and does not comprise submitting the payment request to the provider institution computing system for processing over the network;
retrieve, based on receiving at least one of the first payment attribute and the second payment attribute, a subset of a plurality of first rules to apply to a first database to retrieve a first plurality of payment records, the subset of the plurality of first rules varying according to an account type associated with a first requested payment records, wherein the first plurality of payment records is a subset of payment records stored in the first database;
selectively retrieve, based on the retrieved subset of the plurality of first rules, the first plurality of payment records from a plurality of systems of record associated with the provider computing system by applying at least a first rule to retrieve processed payments, a second rule to retrieve pending payments, and a third rule to retrieve scheduled payments, wherein the plurality of first rules are specific to the provider computing system;
compare, by the comparison circuit, the first payment attribute and the second payment attribute a to one or more attributes of each of the retrieved plurality of payment records to determine if the first payment attribute and the second payment attribute represent an exact duplicate payment request;
determine the first payment attribute and the second payment attribute do not represent an exact duplicate payment request in response to determining that the one or more attributes of each of the received first plurality of payment records do not match each of the first payment attribute and the second payment attribute;
retrieve, based receiving on at least one of the first payment attribute and the second payment attribute and in response to determining that the first payment attribute and the second payment attribute do not represent an exact duplicate payment request, a subset of a plurality of second rules to apply to a second database that is external to the provider computing system to retrieve a second plurality of payment records, the subset of the plurality of second rules varying according to an account type associated with a second requested payment record, wherein the second plurality of payment records is a subset of payment records stored in the second database;
selectively retrieve, via a second secure encrypted communication session with the second database based on the retrieved subset of the plurality of second rules, the second plurality of payment records from the second database;
filter, by the filtering circuit, based on a type of payment record and a given time period in accordance with the subset of the plurality of second rules comprising a fourth rule, the second plurality of payment records to exclude one or more payment records from the plurality of payment records outside of the given time period by applying at least the fourth rule to identify future recurring payments, wherein the second plurality of payment records are retrieved from a second database that is external to the provider computing system in response to the determination that the payment request is not an exact duplicate payment request;
prepare the second plurality of payment records for comparison to the first payment attribute and the second payment attribute based on the type of the second plurality of payment records in accordance with the plurality of second rules, by producing, by the filtering circuit, a subset of the filtered second plurality of payment records for a second comparison including an aggregated payment record, wherein the subset of the second plurality of payment records is produced by:
determining that two or more payment records of the subset of the filtered second plurality of payment records are associated with a given time period, wherein each payment record of the subset of the filtered second plurality of payment records has a respective payment amount; and
producing the aggregated payment record by aggregating the respective payment amounts of the two or more of the filtered second plurality of payment records associated with the time period to create a total payment amount for the two or more of the filtered second plurality of payment records, wherein the total payment amount of the aggregated payment record does not match a single payment record stored on the second database;
compare, by the comparison circuit, the first payment attribute and the second payment attribute to one or more attributes of the prepared, filtered second plurality of payment records to determine if the first payment attribute or the second payment attribute represents a potential duplicate payment request, wherein at least a first of the one or more attributes of the prepared, filtered second plurality of payment records comprises an aggregated payment amount, wherein the aggregated payment amount is not associated with a single payment record of the plurality of second payment records;
determine the first payment attribute or the second payment attribute represents a potential duplicate payment request in response to one or more of the first payment attribute or the second payment attribute matching the one or more attributes of the aggregated payment record;
in response to determining that the first payment attribute or the second payment attribute represents a potential duplicate payment request, provide to the user, via the user interface provided to the display device of the user device, a pop-up notification describing the aggregated payment record, the potential duplicate payment request, and a specific payment attribute causing a potential duplicate condition, the pop-up notification comprising an input option configured to submit the payment request that is temporarily unselectable and grayed out to indicate that the user must change one or more of the first payment attribute or the second payment attribute to submit the payment request, wherein the input option is inoperable until a user input altering the first payment attribute via a first editable field or the second payment attribute via a second editable field request is received within the pop-up notification;
receive, from the user via the user interface provided to the display device, a user input altering the first payment attribute or the second payment attribute within the pop-up notification, wherein the user input altering the first payment attribute or the second payment attribute alters the payment request such that the payment request is not a potential duplicate payment request with the aggregated payment record;
allow, based on the received user input, the user to select the input option to submit the payment request within the pop-up notification; and
submit, by the network interface based on the user input selecting the input option, the payment request to the provider computing system.

22. The system of claim 21, the memory further storing instructions that are executable by the at least one processor to:
determine a total payment amount of a time interval by adding a first payment amount of a first payment record of the first plurality of payment records associated with the time interval to a second payment amount of a second payment record of the first plurality of payment records associated with the time interval,
wherein the first comparison is performed using the determined total payment amount, wherein the determined total payment amount is not associated with a single payment record of the first plurality of payment records.

23. The system of claim 22, wherein the notification comprises a second input option configured to cancel the payment request.

24. The system of claim 21, wherein each of the subset of the plurality of first rules and the subset of the plurality of second rules is based on at least one of identities of the plurality of systems of record, payment types of the plurality of payment records, or account types of the plurality of payment records.

25. The system of claim 21, wherein each of the first plurality of payment records and the second plurality of payment records is associated with a processed payment, a pending payment, a scheduled payment, or a future recurring payment.

26. The system of claim 21, wherein the first payment attribute and the second payment attribute include at least one of a payment funding account, a payment date, a payment amount, a payment source, and a payment destination, wherein the comparing the first payment attribute and the second payment attribute to one or more attributes of each of the retrieved first payment records includes comparing the first payment attribute and the second payment attribute to at least a payment funding account, a payment date, a payment amount, a payment source, and a payment destination of each of the retrieved first plurality of payment records.

27. The system of claim 21, wherein the first payment attribute and the second payment attribute include at least one of a payment amount and a payment destination, wherein comparing the first payment attribute and the second payment attribute to one or more attributes of each of the filtered plurality of payment records includes comparing the first payment attribute and the second payment attribute to at least a payment amount and a payment destination of each of the filtered second plurality of payment records.
